(19) United States
(12) Patent Application Publication
(10) Pub. No.: US 2005/0201208 A1
(43) Pub. Date: Sep. 15, 2005

(54) Quick timer setting display device

(75) Inventor: Yoshiaki Takahashi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/076,852

(22) Filed: Mar. 11, 2005

(30) Foreign Application Priority Data
Mar. 12, 2004 (JP) 2004-070642

(51) Int. Cl. G04C 19/00

(52) U.S. Cl. 368/69

(57) ABSTRACT

The present invention provides a timer setting display device wherein the timer setting can be easily performed in accordance with needs in the daily life environment and the like and the household duties are compatible with television viewing. The timer setting display device comprises a key input means for inputting timer setting display condition, a control microcomputer, and a display means on-screen displaying input conditions and timer setting displays, wherein output is performed by selectively inputting timer time assignments, displaying time intervals, and displaying characters. Moreover, the time setting display device displays the selected characters which the display time intervals are automatically allocated based on the assigned timer time according to the input from the input means. In this invention, the display means is a television set, the key input means is a remote control device for television control, in which a screen display/audio display is used.

The present application is based on and claims priority of Japanese patent application No. 2004-070642 filed on Mar. 12, 2004, the entire contents of which are hereby incorporated by reference.

### BACKGROUND OF THE INVENTION

1. Field of the Invention

The present invention relates to a timer setting display device having a timer function which informs an elapsed time set by using a display function of a device having the display function such as a household television, and the like.

In the daily life environment, or during work at a factory and the like or at an office, there are many cases where a timer mechanism is needed to tell an elapsed time with a time interval according to a working schedule. Although it is possible to know the time itself by a clock, it is necessary to watch a clock face and the like consciously, which makes it difficult to concentrate on the work. For this reason, a timer function is useful which tells a predetermined elapsed time by calling attention. Many methods are proposed which allow us to set time intervals arbitrarily and also inform the elapsed time with detailed time intervals as the time elapses.

2. Description of the Related Art

According to the method described in the Japanese Patent Application Laid-Open Publication No. 2000-009862 (Patent Document 1), an elapsed time is displayed and simultaneously, display contents are changed to the remaining time from a predetermined elapsed time point. However, the timer function is limited only to that time point, and the display of a display device must be watched thereafter. Furthermore, the display device itself is a dedicated digital display device which displays only numbers.

In contrast, according to the method described in the Japanese Patent Application Laid-Open Publication No. 2001-022282 (Patent Document 2), a predetermined time interval is divided further into finer divisions and displayed in colors until time-up, and simultaneously a number display of the remaining time is displayed. In addition, a screen display is to be made using a liquid crystal display as a display device.

These timer functions are convenient for time management of the work at a factory or an office or the like. On the other hand, in the daily life environment, a much simpler method to set a timer time is desired, and also as for a display device, it is expensive to prepare a dedicated display device which requires a new installation space.

In addition, in the circumstances where these timer functions are needed, two or more events may be considered to proceed simultaneously. In the daily life environment, while watching and enjoying a television program, cooking of boiled food or broiled food or washing by a washing machine or the like may be being done simultaneously. Therefore, very frequently it is difficult to watch a display device. In such circumstances, even if a timer display is turned on, attention must be paid to watch it intentionally, and also it is nuisance to inform the time frequently by calling attention by a beep sound and the like, which may not be desirable.

### SUMMARY OF THE INVENTION

The present invention aims at providing a device which can perform a timer setting in accordance with various needs and can adopt a display/announcement device thereof. Moreover, it aims at making these timer settings easy, so that household duties such as cooking or washing and the like can be compatible with television viewing.

The present invention comprises a key input device for inputting timer setting display conditions, a control microcomputer, and a display means which can display these input conditions and timer display conditions by an image display means, wherein the control microcomputer provides screen display output which allows to selectively input timer time assignments, display time intervals, and display characters, and controls display characters selected by automatically allocating the display time intervals for the timer time assignments according to the input from the input means and display characters selected by the time intervals assigned together with the timer time assignments.

In addition, the present invention relates to a timer setting display device, wherein the display device is a television set, the key input means is a remote control device for television control, and an screen display and/or an audio display are used.

The timer setting display device according to the present invention displays a timer setting time by automatically allocating a display time interval or by using a predetermined time interval. Furthermore, the device can display not only these displays by a digital number display, but also can display an integrated elapsed time or a remaining time by using various characters. Since such timer input operation can be performed selectively by viewing setting conditions on a screen of the image display device by utilizing a television display and the like, it is possible for anyone to set a time by extremely simple operation, without making any mistake.

In addition, since such timer display and operation can be performed by using a display screen such as a television set and the like or by using audio output, it is possible to perform various duties including household work or cooking or the like compatibly.

### BRIEF DESCRIPTION OF THE DRAWINGS

FIG. 1 is an example of a menu screen of a timer setting according to the present invention;

FIG. 2 is an example of a selection screen of a timer display setting according to the present invention;

FIG. 3 is an example of the selection screen of the timer setting according to the present invention;

FIG. 4 is an example of the selection screen of a timer clock according to the present invention;

FIG. 5 is a display example of a sandglass of the timer according to the present invention;

FIG. 6 is an example of the selection screen of the timer clock according to the present invention;

FIG. 7 is a flow chart showing a timer control and operation according to the present invention; and

FIG. 8 is a block diagram of a device according to the present invention.

### DETAILED DESCRIPTION OF THE PREFERRED EMBODIMENTS

According to the present invention, a timer setting is performed by an image display means which utilizes a screen display such as a television set and the like, wherein the timer setting can be selectively performed either by a setting in which a time interval for display/announcement is only fixed by an input time or by a setting in which the time interval for display/announcement can be selected together with the input time. Furthermore, this display/mode is made with an updated time obtained by adding an elapsed time or with an updated time obtained as a remaining time by subtracting the elapsed time, or the display mode can be selected from a digital display or a display by character and change thereof such as a sandglass and the like.

According to the present invention, the timer setting can be easily performed by receiving a signal inputted from a key operation by a light receiving section provided at a television set in a manner similar to the remote control by television infrared rays and by providing “on screen display” as the image display means which displays an input operation on a television screen.

In addition, after a timer setting is performed, since the timer display can be made by superimposing a receiving screen of television broadcasting or a screen of a video player on the television display screen, it is possible to use the timer setting display device under such circumstances like enjoying television pictures while doing domestic duties such as cooking or washing or the like. Thus, a nuisance such as a mess of cooking of broiled or boiled food can be avoided.

The timer setting is performed as follows. When a timer operation time is inputted, predetermined display time intervals, for example, 1, 2, 3, and 5 minutes, are set, or when a time of 15 minutes is inputted, the minimum time interval which can be divided by the setting time, that is, a time interval of 3 minutes is automatically selected, or furthermore any of these time intervals, for example, 1, 3, and 5 minutes, can be selected.

Moreover, these timer displays may display a progress by adding the elapsed time for every display time interval, or may display the remaining time by subtracting the elapsed time for every display time interval.

When the elapsed time is displayed, it is possible to grasp the duration of work progress or the like, or when the remaining time is displayed by subtraction, it is convenient to know a remaining time margin.

In addition, these display modes may be a digital display of time, or a display by character and time variation mode thereof such as a sandglass and the like and can be selected according to user's tastes or easiness of viewing. In the case of the display by a sandglass, when the status of the sandglass is displayed by the amount of sand that gradually decreases as the time elapses, the display is numerically crude but it is convenient to know the remaining time at a glance.

Further, together with the display of the elapsed time or remaining time, the input time may be displayed, and combinations such as display contents or display items may be displayed for the convenience of use.

### Embodiment 1

Hereinafter, the operation procedure of timer setting of a timer setting display device according to the present invention will be described.

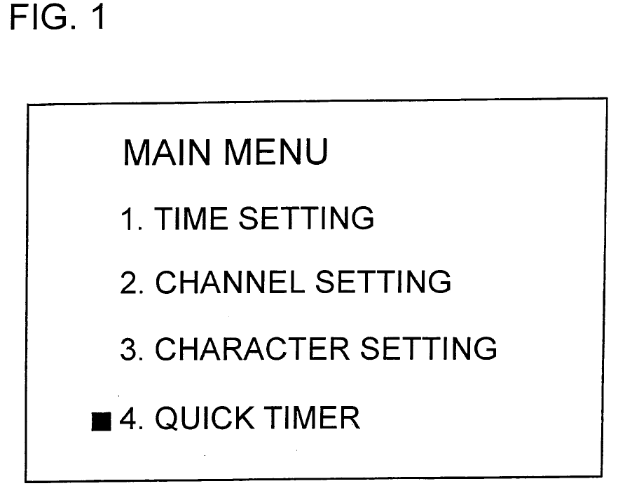

First, the timer setting will be described. FIG. 1 shows a main menu screen of the timer setting displayed on a monitor screen such as a television set and the like according to the present invention. The monitor screen according to the present invention is not limited to the television set, and can be any kind of a display device which have at least a image display function including a personal computer.

The example shown in the figure, as a main menu of monitoring the timer setting display device according to the present invention, shows the display status of a timer condition setting according to the present invention together with a menu such as a clock setting for displaying with a clock function, a channel setting for selecting a television channel, and an image setting of a wide screen display and the like. Here, the timer condition setting is an easy operation which can be performed by following a display screen described below which is called a quick timer.

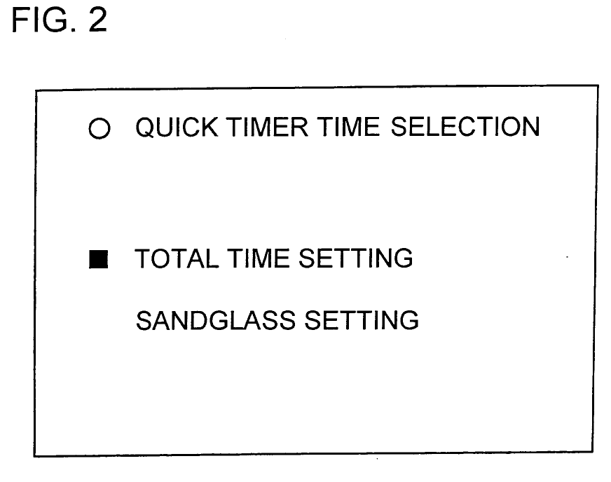

Next, the quick timer clock selection will be explained. When the quick timer is selected by using the main menu shown in FIG. 1, there appears a quick timer clock selection screen shown in FIG. 2.

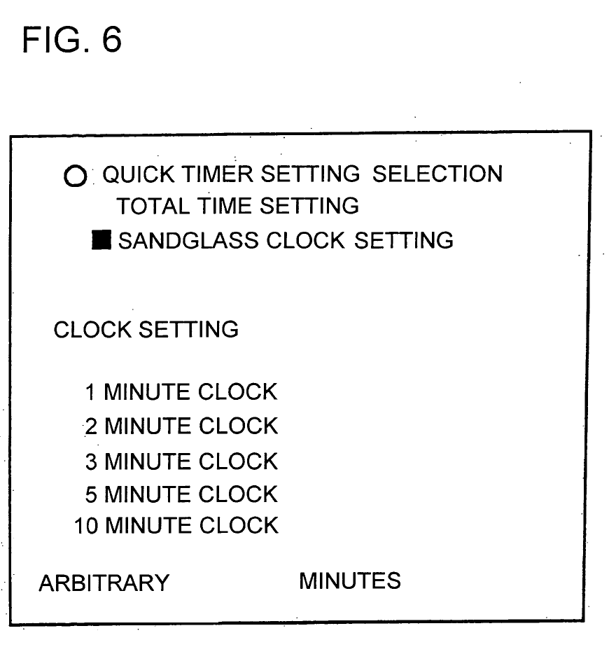

On this screen, an elapsed total time setting mode which performs a timer display of the total time from the starting time of time measurement at every time interval predetermined by the input of a time setting time and a sandglass setting mode in which the time interval for the timer display (for example, 3 minute clock, 5 minute clock, or 10 minute clock) can be selected immediately after the input time of the timer time or after the starting time of the time is selected. When the sandglass setting mode is selected, the screen is temporarily switched to a sandglass clock setting of a quick timer clock selection shown in FIG. 6 as described later, and after a sandglass clock is selected, it is switched to a quick timer setting described below.

When the elapsed total time setting mode is selected on the above-described quick timer clock selection screen, the quick timer setting selects the timer setting time (wherein the timer setting time can read the time of clock function provided in the timer setting display device (such as a television set and the like) at the input time of timer setting), an addition display or a subtraction display as a timer display mode, and a design and a character for displaying. In the case of the addition display, the elapsed total time from the starting time of operation (the starting time of the time measurement) is displayed successively, and in the case of the subtraction display, the total time up to the goal time set (wherein the total time refers to the remaining time up to the goal time) is displayed successively.

The input time is illustrated by hours, minutes, and seconds, but if necessary, the display of second can be eliminated. When the addition display is selected as the display mode, the time course is displayed at every fixed time interval from the starting time of operation. In addition, when the subtraction display is selected, the remaining time is displayed at every fixed time interval from the starting time of operation. Needless to say, it is possible to continuously display the elapsed total time instead of every fixed time interval.

A clock design setting can be selected from various designs, for example, such as a design in which the elapsed time is displayed by a character such as a sandglass and the like, or a display by a bar graph, a pie chart, or a stopwatch surface having a circulating hour hand, a minute hand, and a second hand though not shown specifically in the figures.

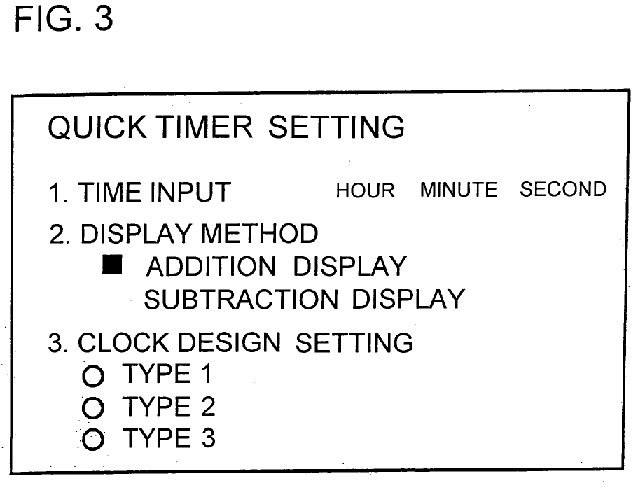

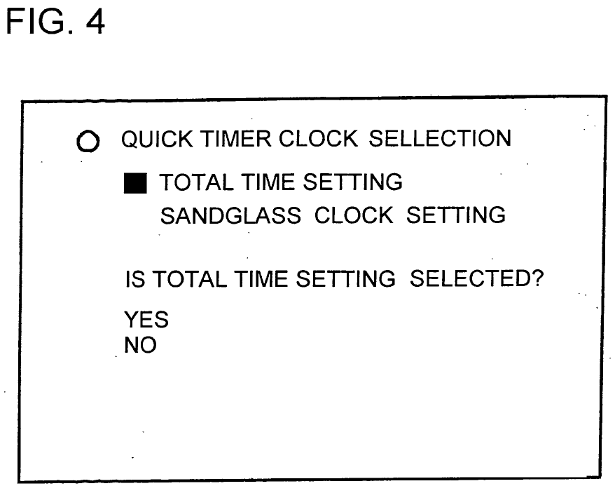

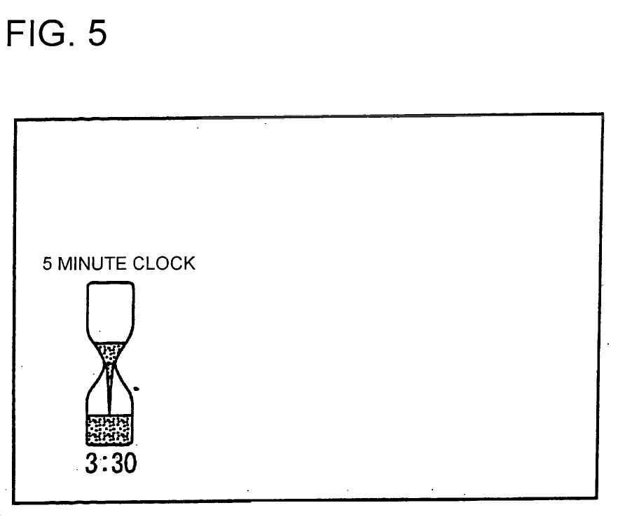

When the above-described timer setting operation is performed, there appears a final confirmation screen shown in FIG. 4, and it is possible to confirm the items set above. The final confirmation screen shown in FIG. 4 shows the final confirmation screen which is selected by the elapsed total time setting mode. A user is asked to select “Yes” or “No”, and the final confirmation of the setting is arranged to be made. When the user selects “Yes”, the quick timer setting is completed, and the operation starts. FIG. 5 shows an example of the timer display of the present invention displayed after the above timer setting is completed. In this example, the addition display on the screen of FIG. 3 and the sandglass in the clock design setting are selected, and a display, showing that the sand on the top dropping downward as the time elapses, is the most preferable as a display of a familiar sandglass. In addition, for example, when a time for 10 minutes or 15 minutes is measured by using a 5 minute clock, the sandglass, displayed as in the normal use, is reversed upside down and then it is possible to display a character for measuring of the next 5 minutes. In this case, naturally, in the display, the amount of sand that is accumulated on the bottom is moved to the top, and the display changes to indicate the sand dropping downward. Further, in addition to the sandglass display, it is possible to display a digital value indicating the elapsed time below the sandglass. For the convenience of a user, it is possible to add display items if necessary, in order to make the degree of the present elapsed time much clearer by displaying the setting time in addition to those described above. In addition, the clock of the selected sandglass (clock for the number of minutes) may be displayed with a digital value, for example, “5 minute clock” and the like, superimposed on the sandglass display.

In the selection of the above-described clocks of sandglasses, when the sandglass setting is selected on the above-described quick timer clock selection screen, the display screen is switched to the display screen of FIG. 6 and displayed. In the example of a screen for selecting the sandglass clock, the timer interval for the timer display is set by selecting the sandglass clock. Here, when the sandglass clock is selected, the screen returns to the process of the above-described quick timer setting.

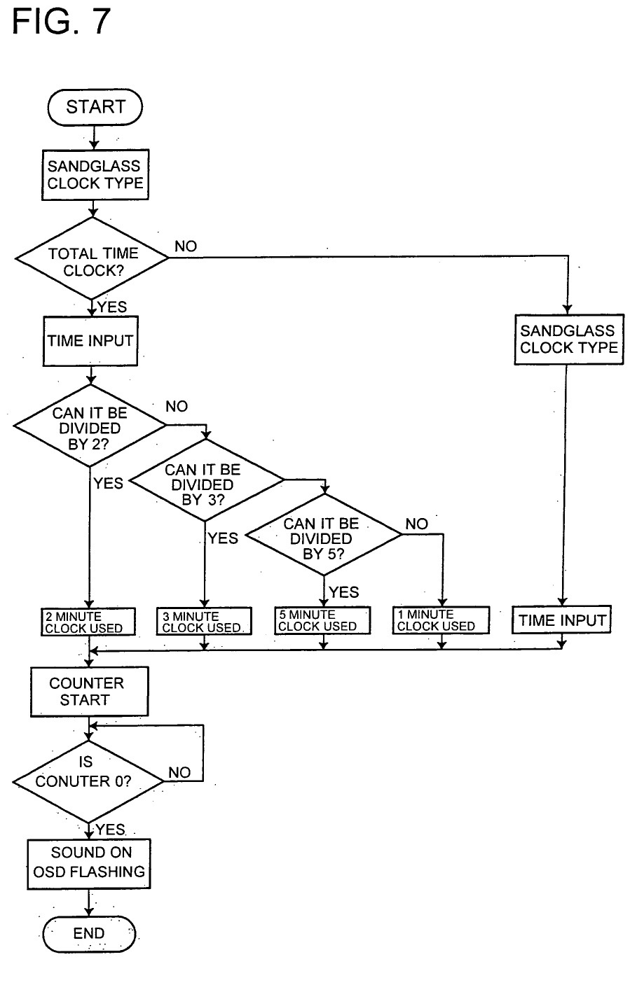

In FIG. 6, the sandglass clock may be freely selected by user's input, or as shown in the flow chart of FIG. 7, the timer operation may be selected automatically from a timer setting operation.

That is, after the sandglass clock is set, and after whether the total time is selected or not is asked, and when “No” is inputted, the mode for selecting the sandglass clock setting is entered and the user can input the sandglass time freely. In addition, after the sandglass clock is set, and after whether the total time is selected or not is asked, and when “Yes” is inputted, the total time is asked to be inputted. When the time is inputted, the timer setting operation calculates whether the inputted time can be divided by 2, by 3, or by 5 in this order, and according to this outcome, a 2 minute clock, or a 3 minute clock, or a 5 minute clock is selected. In case the inputted time cannot be divided by any of these numbers, a 1 minute clock is to be selected. When the sandglass time (clock) is selected, a counter is started and reset to zero, and when a sound effect is turned on, a sound-on image display means (on screen display) starts flashing.

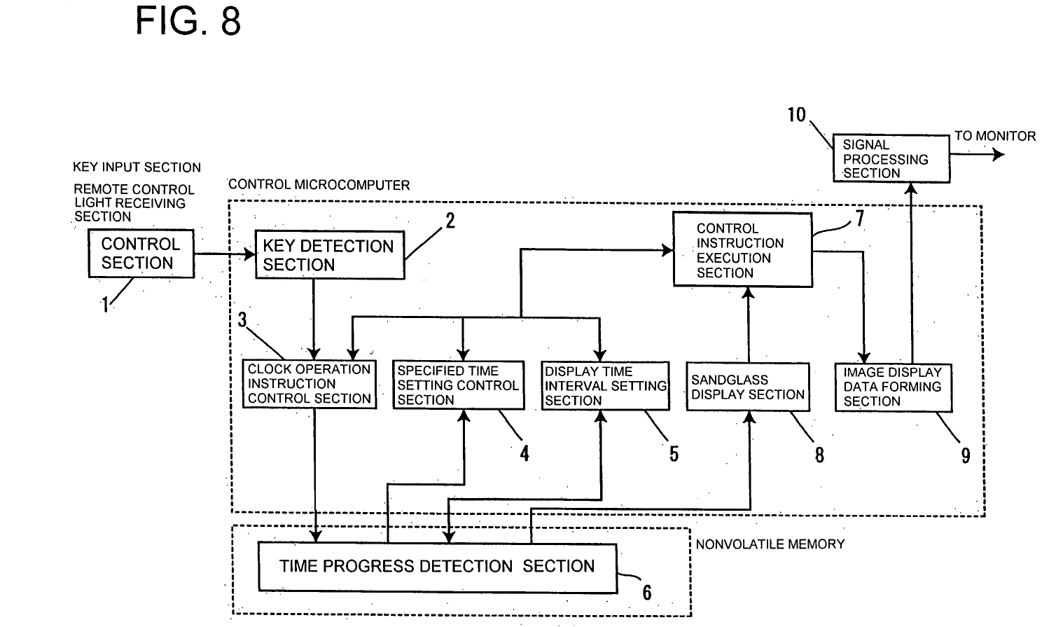

FIG. 8 shows a block diagram of the present invention, comprising a control section which has an input device such as a key and the like to perform a timer setting operation, a control microcomputer which outputs a timer setting condition or a display condition to a monitoring section, and measures the timer operation time in accordance with the timer setting condition based on the timer setting signal outputted from the control section and the time progress such as display time interval and the like, and outputs patterns and number values for displaying, and a signal processing section which transmits display signals to a monitoring device such as a television set and the like.

The control section 1 is the input means having the key to perform the key input. In the case of the television set used as the display section, the key for a remote control device may be used as the input key, and signals may be transmitted to an infrared light receiving section of the television set, or it may be a ten-key keyboard.

A key detection section 2 receives input signals for selection of a front panel display or menu items from a remote control key and the like of the control section and sends them to a clock operation instruction control section 3.

The clock operation instruction control section 3 controls clock operation instructions in accordance with the key information and sends them to each executive section and setting section.

After receiving the instructions, a specified time setting control section 4 sets and controls a specified time desired by a user and a display time interval setting section 5 sets and controls the elapsed time interval to display an interim progress, for the specified time.

On the other hand, a time progress detection section 6 actually measures the elapsed time and the specified time interval by using a clock function provided in the television set itself and sends necessary measured data to the specified time setting control section, the display time interval setting section, and a sandglass display section. Basically, an internal timer section of the microcomputer performs this task, however, an external nonvolatile memory can be used for counting.

After receiving these data output, a control instruction execution section 7 instructs each control section such as clock setting, clock counting, elapsed time display sections, and the like.

The sandglass display section 8 stores several kinds of characters in advance and outputs selected characters according to the elapsed time.

A character display data forming section 9 outputs screen display data from the data of the elapsed time, total time, sandglass and the like, in accordance with the above.

These control and operation will be explained by using a flow chart. The process starts from the step of a start, and the next step is selected from the two settings of either the total time setting which allocates the display time interval automatically from the input time or the sandglass setting which selects display time intervals. In the next step, when the total time setting is selected to be “Yes”, the operation enters a time input step.

In this case, since the predetermined time intervals are automatically allocated, the operation enters the next step in which these predetermined time intervals, that is, 2, 3, or 5 minute clock, or 1 minute clock when the input time cannot be divided by any of these numbers are allocated.

For example, when the input time can be divided by 2 in units of minutes, then the “Yes” route is taken and the step of a counter start is entered. In the case of “No”, the operation enters the next step in which it is judged whether the input time can be divided by 3. Hereinafter, the similar procedure is repeated, and when the judgment is “No” in all the cases, the 1 minute clock is allocated which displays the time at a 1 minute interval.

In addition, in the case of “No” in the above-described total time setting selection, the sandglass clock selection step is entered, and the step of a time input together with the counter start is followed.

The counter operation is repeated until the count becomes zero corresponding to the input time, and the updated time is displayed by “Yes”. These displays are performed by using a beep sound (sound on) or by using “on screen display”, and a series of timer displays is completed.

In a television set having a timer setting display function according to the present invention, a timer setting is simple and a timer operation can be displayed at various time intervals and with various modes. Therefore, it is possible to adopt it regardless of working environments. In particular, in usual daily life, by using the display of “on screen display” which utilizes a display screen of a television set and the like in the household environment, it is possible to assist daily life smoothly. Further, not limited only to its convenience, it is also possible to contribute broadly to the development of industry by its broad use.

1. A timer setting display device comprising a key input device which inputs timer setting display conditions, a control microcomputer, and display means which can display these input conditions and timer display conditions by using an image display means, wherein the control microcomputer provides screen display output which selectively inputs timer time assignments, display time intervals, and display characters, and controls display characters selected by automatically allocating the display time intervals for the timer time assignments according to the input from the input device and by using characters selected by the time interval assigned together with the timer time assignment.

2. The timer setting display device according to claim 1, wherein the display means is a television set, the key input means is a remote control device for television control, and the timer display is performed by a screen display and/or an audio display.
